(19) United States
(12) Patent Application Publication
(10) Pub. No.: US 2026/0163471 A1
(43) Pub. Date: Jun. 11, 2026

(54) ELECTRONIC DEVICE COMPRISING PROTECTION CIRCUITRY WITH RESPECT TO TRANSISTOR IN RECTIFYING CIRCUITRY CONFIGURED TO RECTIFY ALTERNATING CURRENT SIGNAL

(71) Applicant: Samsung Electronics Co., Ltd., Suwon-si (KR)

(72) Inventors: Keonwoo KIM, Suwon-si (KR); Moonyoung KIM, Suwon-si (KR); Jinhyung LEE, Suwon-si (KR)

(21) Appl. No.: 19/319,601

(22) Filed: Sep. 4, 2025

Related U.S. Application Data
(63) Continuation of application No. PCT/KR2025/013008, filed on Aug. 26, 2025.

(30) Foreign Application Priority Data
Dec. 11, 2024 (KR) 10-2024-0184215

(51) Int. Cl. H02M 1/32; H02M 1/092; H02M 1/42; H02M 1/44

(52) U.S. Cl. CPC H02M 1/32; H02M 1/092; H02M 1/4208; H02M 1/44

(57) ABSTRACT

An electronic device includes: a port configured to receive an alternating current signal. The electronic device includes a capacitor. The electronic device includes a transistor configured to control an electric connection between the port and the capacitor. The electronic device includes control circuitry connected to a gate electrode of the transistor. The electronic device includes switching circuitry, coupled to a signal path between the gate electrode and the control circuitry, configured to connect the signal path to a ground node. The control circuitry is configured to control, based on a voltage of the alternating current signal received through the port, the switching circuitry to transmit, to the ground node, a control signal to be transmitted to the gate electrode from the control circuitry through the signal path.

### CROSS-REFERENCE TO RELATED APPLICATIONS

This application is a continuation of International Application No. PCT/KR2025/013008 designating the United States, filed on August 26, 2025, in the Korean Intellectual Property Receiving Office and claiming priority to Korean Patent Application No. 10-2024-0184215, filed on December 11, 2024, in the Korean Intellectual Property Office, the disclosures of each of which are incorporated by reference herein in their entireties.

### BACKGROUND

### Field

The disclosure relates to an electronic device comprising protection circuitry with respect to a transistor in rectifying circuitry configured to rectify an alternate current signal.

### Description of Related Art

An electronic device may receive a power signal from an infrastructure for providing power, referred to as a power distribution system. The electronic device receiving the power signal may execute various functions based on a design of the electronic device, based on the power signal. The power signal received by the electronic device is an alternate current signal. Complexity of the power distribution system, or an inflow of an unintended power into the power distribution system, such as lightning, may cause noise (e.g., a rapid change of a voltage and/or a current) of the power signal received by the electronic device.

The above-described information may be provided as a related art for the purpose of helping understanding of the present disclosure. No assertion or determination is made as to whether any of the above description may be applied as a prior art related to the present disclosure.

### SUMMARY

An electronic device according to an example embodiment may comprise a port configured to receive an alternate current signal. The electronic device may comprise a capacitor. The electronic device may comprise a transistor configured to control an electric connection between the port and the capacitor. The electronic device may comprise control circuitry connected to a gate electrode of the transistor. The electronic device may comprise switching circuitry, that is coupled to a signal path between the gate electrode and the control circuitry, configured to connect the signal path to a ground node. The control circuitry may be configured to control, based on a voltage of the alternate current signal received through the port, the switching circuitry to transmit, to the ground node, a control signal to be transmitted to the gate electrode from the control circuitry through the signal path.

In an example embodiment, power circuitry may be provided. The power circuitry may comprise a port configured to receive an alternate current signal. The power circuitry may comprise rectifying circuitry configured to rectify the alternate current signal. The power circuitry may comprise a capacitor configured to be charged by the alternate current signal rectified by the rectifying circuitry. The rectifying circuitry may comprise a diode including an anode coupled to the port and a cathode coupled to the capacitor. The rectifying circuitry may comprise a transistor including a drain electrode coupled to the anode and a source electrode coupled to a ground node. The rectifying circuitry may comprise control circuitry configured to transmit a control signal to a gate electrode of the transistor based on a voltage of the drain electrode. The rectifying circuitry may comprise switching circuitry, coupled to a signal path between the gate electrode and the control circuitry, configured to change a voltage of the gate electrode to a voltage of the ground node.

In an example embodiment, a method to control a transistor of rectifying circuitry may be provided. The method may comprise identifying a voltage of an alternate current signal transmitted to the rectifying circuitry. The method may comprise identifying a rate of change of the voltage. The method may comprise, based on identifying the rate of change lower than or equal to a threshold rate of change, controlling the transistor based on a specified period for rectifying the alternate current signal. The method may comprise, based on identifying the rate of change greater than the threshold rate of change, changing a voltage of a gate electrode of the transistor to a voltage of a ground node.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example electronic device according to various embodiments;

FIG. 2 is a block diagram illustrating an example hardware configuration of an electronic device according to various embodiments;

FIG. 3 is a circuit diagram illustrating example control circuitry with respect to a transistor of rectifying circuitry according to various embodiments;

FIG. 4 is a circuit diagram illustrating a relationship between noise of an alternate current signal and a voltage of a gate electrode of a transistor according to various embodiments;

FIG. 5 is a flowchart illustrating an example operation of control circuitry associated with a voltage of an alternate current signal according to various embodiments;

FIG. 6 is a graph illustrating an example operation of control circuitry based on noise of an alternate current signal according to various embodiments;

FIG. 7 is a flowchart illustrating an example operation of control circuitry associated with a voltage of a gate electrode of a transistor in rectifying circuitry according to various embodiments;

FIG. 8 is a graph illustrating an example operation of control circuitry based on a voltage of a gate electrode of a transistor in rectifying circuitry according to various embodiments; and

FIG. 9 is a circuit diagram illustrating rectifying circuitry connected to control circuitry according to various embodiments.

### DETAILED DESCRIPTION

Hereinafter, various example embodiments of the present disclosure will be described with reference to the accompanying drawings.

The various embodiments of the present disclosure and terms used herein are not intended to limit the technology described in the present disclosure to specific embodiments, and should be understood to include various modifications, equivalents, or substitutes. In relation to the description of the drawings, a reference numeral may be used for a similar component. A singular expression may include a plural expression unless it is clearly meant differently in the context. In the present disclosure, an expression such as "A or B", "at least one of A and/or B", "A, B or C", or "at least one of A, B and/or C", and the like may include all possible combinations of items listed together. Expressions such as "1st", "2nd", "first" or "second", and the like may modify the corresponding components regardless of order or importance, are only used to distinguish one component from another component, but does not limit the corresponding components. When a (e.g., first) component is referred to as "connected (functionally or communicatively)" or "accessed" to another (e.g., second) component, the component may be directly connected to the other component or may be connected through another component (e.g., a third component).

The term “module” used in the present disclosure may include a unit configured with hardware may be used interchangeably with terms such as component and/or circuit, and the like. The module may be an integrally configured component or a minimum unit or part thereof that performs one or more functions. For example, a module may be configured with an application-specific integrated circuit (ASIC).

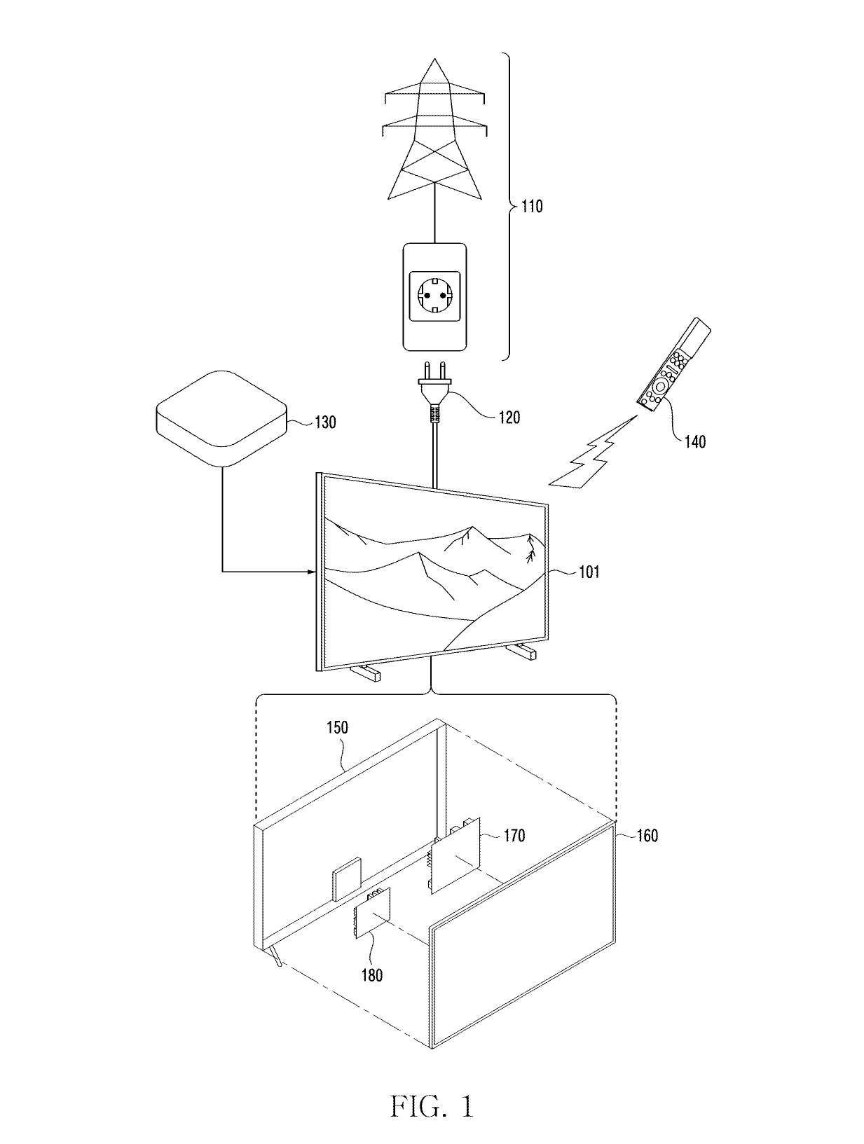

FIG. 1 is a diagram illustrating an example electronic device 101 according to various embodiments. The electronic device 101 may be described as an electronic device capable of displaying a video. For example, the electronic device 101 may include, without limitation, a television (TV), a monitor, a computer, a smartphone, a tablet personal computer (PC), a portable media player, a wearable device, a video wall, an electronic frame, etc. The electronic device 101 may be referred to as a display device. Hereinafter, for convenience of description, the device is described by assuming a case that the electronic device 101 is implemented as a TV, but the disclosure is not limited thereto.

The electronic device 101 may be configured to operate by a power (e.g., an alternate (or alternating current; the terms “alternate current” and “alternating current” may be used interchangeably in the disclosure, including the appended claims) current (AC) power signal, and/or an alternate current signal) provided from a power system 110. The power system 110 (or a power distribution system) may be described as an infrastructure constructed to provide the power. The electronic device 101 may include a plug 120 (or a port, an electrical cord) configured to be connected to an electrical outlet (or an outlet, a socket, or a receptacle) positioned at an end of the power system 110. The plug 120 may be connected to a component (e.g., an AC-DC adapter (or an electrical adapter) and/or power circuitry 170 to be described in greater detail below with reference to FIG. 1) of the electronic device 101 for power conversion (e.g., power conversion from an alternate current signal to a direct current (DC) signal (or a direct current power signal)).

While the plug 120 is electrically connected to the power system 110, the electronic device 101 may execute a function for outputting a video, sound, or a combination thereof (e.g., multimedia content) based on the power of the power system 110. When the electronic device 101 receives information indicating the video and/or the sound, the electronic device 101 may execute the function using the information. The information indicating the video and/or the sound may be stored in the electronic device 101 or received from an external electronic device 130 (e.g., a set-top box (STB)) connected to the electronic device 101. The electronic device 101 may include an antenna configured to receive the information wirelessly, or may be electrically connected to the antenna.

While receiving the power from the power system 110 through the plug 120, the electronic device 101 may be driven in accordance with any one of a normal mode (or an active mode, an enabled mode), and a standby mode (or an inactive mode, a disabled mode, a hibernate mode, a sleep mode). The normal mode may be described as a mode that consumes a power greater than power consumption (e.g., a standby power) of the standby mode to output the video. A mode of the electronic device 101 is not limited to the normal mode and the standby mode. In the present disclosure, a term "mode" may be used interchangeably with a term "state". In the standby mode, output of the video and the sound by the electronic device 101 may substantially cease, or may be minimized. In the standby mode, the electronic device 101 may output a message (e.g., "press the power button") guiding an input for switching to the normal mode. The message may be output through a display and/or a speaker of the electronic device 101. In the normal mode, the electronic device 101 may output a video (e.g., a video different from the message) and/or a sound. The electronic device 101 may switch or toggle between the standby mode and the normal mode, based on a user input.

The electronic device 101 may include hardware for receiving an input (e.g., a user input for switching between the standby mode and the normal mode) for control of the electronic device 101. For example, the electronic device 101 may include a switch (or a button) that is at least partially visible through a housing of the electronic device 101. For example, the electronic device 101 may include a touch sensor (e.g., a pressure sensitive touch sensor and/or a capacitive touch sensor) for detecting a touch input on at least a portion of the housing. The user input may include a direct action (e.g., an action of pressing the switch and/or the button, or an action of touching a surface of the housing) of a user with respect to the electronic device 101. The disclosure is not limited thereto, and the user input may be identified by an audio signal indicating a speech of the user received through a microphone. The disclosure is not limited thereto, and the user input may include an indirect action of the user associated with the electronic device 101, based on a remote controller 140.

Referring to FIG. 1, the electronic device 101 may be configured to receive a wireless signal (or an optical signal) of the remote controller 140 based on infrared (IR). The disclosure is not limited thereto, and the remote controller 140 may be configured to transmit the wireless signal, based on Bluetooth, Bluetooth low energy (BLE), near-field communication (NFC), ultra-wideband (UWB), wireless fidelity (WiFi), Wi-direct, and/or another wireless short-range communication protocol. For example, the electronic device 101 may be configured to receive the wireless signal based on the illustrated wireless short-range communication protocol. In both the standby mode and the normal mode, the electronic device 101 may be configured to receive the wireless signal from the remote controller 140.

FIG. 1 includes an exploded perspective view illustrating electronic components included in the electronic device 101. The electronic device 101 may include a housing 150, a display panel 160, power circuitry 170, and main circuitry 180. The housing 150 may include a rear cover (or a rear surface cover or a back cover) of the electronic device 101. The housing 150 may include an object (e.g., a supporting leg and/or video electronics standards association (VESA) mount holes) to support the electronic device 101. A surface of the electronic device 101 in which the housing 150 is visually recognizable, may be described as the rear surface (e.g., a rear side) of the electronic device 101.

Another surface of the electronic device 101, which is opposite to the surface of the electronic device 101 in which the housing 150 is visually recognizable, may be described as a front surface (e.g., a front side) of the electronic device 101. The display panel 160 may be visually recognizable from the front surface of the electronic device 101. The display panel 160 may include a liquid crystal display (LCD), a plasma display panel (PDP), and a plurality of LEDs. The LED of the display panel 160 may include an organic LED (OLED). In an embodiment, the display panel 160 may include electronic paper. In a case that the display panel 160 has a planar shape, the display panel 160 may be referred to as a flat panel display (FPD). In a case that the display panel 160 has a curved shape, the display panel 160 may be referred to as a curved display. In a case that the display panel 160 has a deformable shape, the display panel 160 may be referred to as a bendable display, a flexible display, and/or a rollable display.

The main circuitry 180 may be configured to execute a function (e.g., a function to output an image, a sound, or a combination thereof, a turn-on function, a turn-off function, a function to adjust a volume, a function to change a channel, and/or a function to control an execution of an over the top (OTT) application) of the electronic device 101 described above. For example, the main circuitry 180 may output an audio, an image, a video, or any combination thereof, by controlling the display panel 160 using the information received from the external electronic device 130 (or the antenna of the electronic device 101). For example, the main circuitry 180 may be configured to control the display panel 160. The power circuitry 170 may be configured to provide a power to the main circuitry 180. The power circuitry 170 may be configured to convert the alternate current signal received from the power system 110 into a direct current (DC) signal for driving the main circuitry 180. For example, the power circuitry 170 may be configured to transmit the DC signal to the main circuitry 180.

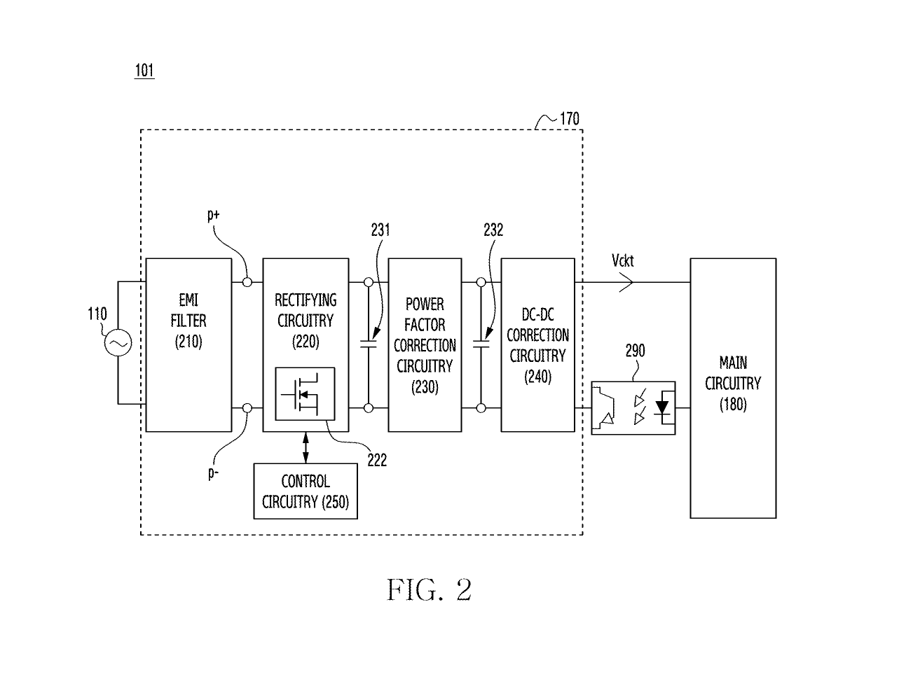

Power consumption of the electronic device 101 may be a sum of power consumption of the display panel 160, the main circuitry 180, and the power circuitry 170. In order to reduce the power consumption, a method of improving conversion efficiency (e.g., a ratio of powers between the AC signal input to the power circuitry 170 and the DC signal output from the power circuitry 170) of the power circuitry 170 may be required. The power circuitry 170 of the electronic device 101 according to an embodiment may include rectifying circuitry configured to rectify the AC signal. In order to increase the conversion efficiency, the rectifying circuitry may be designed to include a circuit element having relatively little conduction loss. For example, the rectifying circuitry may include one or more transistors (e.g., a metal-oxide-semiconductor field effect transistor (MOSFET), a metal-insulator-semiconductor FET (MISFET), and/or a bipolar junction transistor (BJT)) having less conduction loss than the diodes, instead of bridge-structured diodes. An example structure of the power circuitry 170 including the rectifying circuitry will be described in greater detail below with reference to FIG. 2.

The rectifying circuitry including the one or more transistors may be connected to control circuitry for controlling the one or more transistors. A power for driving the control circuitry may also be provided from the power system 110. The control circuitry may transmit a control signal for controlling the one or more transistors to the one or more transistors included in the rectifying circuitry. The control signal may be generated and/or transmitted, based on an AC signal transmitted to the control circuitry.

The AC signal provided from the power system 110 includes noise. When an amplitude and/or a frequency (or a period) of the AC signal is changed outside an intended range by a design of the power system 110, the noise may be described as being included in the AC signal. The noise of the AC signal may be caused by an abnormal operation and/or a failure of a generator, a transformer, and/or a power line included in the power system 110. The noise of the AC signal may be caused by lightning (or other phenomena) applied to the power system 110. The noise of the AC signal may be associated with a demand (e.g., electric energy) with respect to the power system 110.

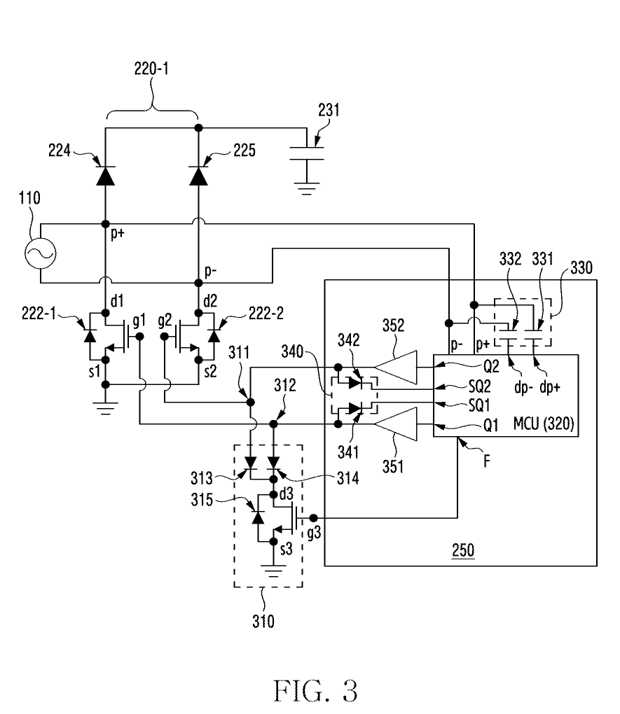

In an embodiment in which the rectifying circuitry of the power circuitry 170 includes the one or more transistors, since the control signal transmitted to the one or more transistors is generated using the AC signal provided from the power system 110, the control signal may include the noise of the AC signal. The noise included in the control signal may cause malfunction and/or damage to the one or more transistors. The power circuitry 170 of the electronic device 101 according to an embodiment may include circuitry for preventing and/or reducing the malfunction and/or the damage of the one or more transistors. For example, the power circuitry 170 (or the control circuitry) may be configured to filter the noise included in the control signal and/or transmit it to another electronic component different from the one or more transistors. Example circuitry for preventing and/or reducing the damage to the one or more transistors due to the noise of the control signal will be described in greater detail below with reference to FIGS. 3 to 9.

FIG. 2 is a block diagram illustrating an example hardware configuration of an electronic device 101 according to various embodiments. Referring to FIG. 2, a block diagram of the power circuitry 170 and the main circuitry 180 of the electronic device 101 of FIG. 1 is illustrated.

Referring to FIG. 2, main circuitry 180 is illustrated as example electronic components of an electronic device 101 connected to power circuitry 170. The main circuitry 180 of FIG. 2 may correspond to the main circuitry 180 of FIG. 1. The disclosure is not limited thereto, and another electronic component (e.g., the display panel 160 and/or driver circuitry for driving the display panel 160 of FIG. 1) of the electronic device 101 may also be connected to the power circuitry 170. The power circuitry 170 may generate, from an AC signal provided from a power system 110, a DC signal required for driving the remaining electronic components. For example, the power circuitry 170 may transmit the DC signal having a voltage Vckt required to drive the main circuitry, to the main circuitry 180.

Referring to FIG. 2, the power circuitry 170 may include an electromagnetic interference (EMI) filter 210, rectifying circuitry 220, power factor correction circuitry 230, and/or DC-DC correction circuitry 240. A power included in the AC signal received from the power system 110 may be sequentially propagated or transmitted from the EMI filter 210, to the rectifying circuitry 220, the power factor correction circuitry 230, and the DC-DC correction circuitry 240.

The EMI filter 210 may be disposed between the power system 110 (or the plug 120 of FIG. 1) and the rectifying circuitry 220. The EMI filter 210 may be configured to filter the AC signal to be transmitted to the rectifying circuitry 220. The EMI filter 210 may be configured to reduce noise (e.g., noise caused by a frequency component higher than a frequency of the AC signal, intended by the power system 110) included in the AC signal to be transmitted to the rectifying circuitry 220.

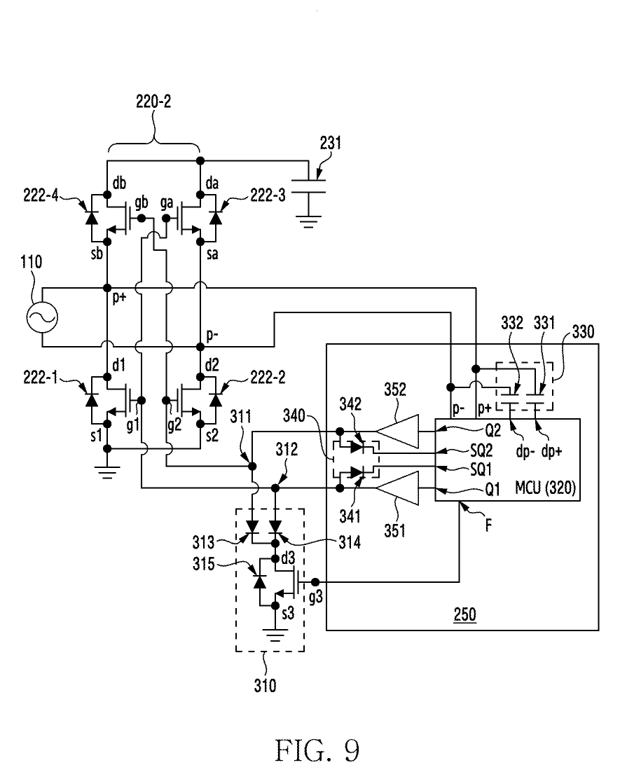

The rectifying circuitry 220 may be configured to rectify the AC signal provided by the power system 110. Referring to FIG. 2, the rectifying circuitry 220 connected to nodes p+ and p- extending from the EMI filter 210 is illustrated. A potential difference between the nodes p+ and p- may correspond to a voltage of the AC signal filtered by the EMI filter 210. The rectifying circuitry 220 may be configured to rectify the AC signal using a transistor 222. The number of transistors 222 included in the rectifying circuitry 220 may be one or more. The rectifying circuitry 220 configured to rectify the AC signal based on the transistor 222 may be referred to as an active bridge rectifying circuitry (or bridgeless rectifying circuitry). Since a potential difference between an anode and a cathode of a diode is (generally) larger than a potential difference between a drain electrode and a source electrode of the transistor 222, loss (e.g., loss by an electric current flowing in the diodes) of the rectifying circuitry 220 including the transistor 222 may be less than loss (e.g., loss by an electric current flowing in the transistor 222) of rectifying circuitry including diodes of a bridge structure. An example structure of the rectifying circuitry 220 including various numbers of transistors will be described with reference to FIGS. 3 and 9. The rectifying circuitry 220 may be configured to perform half-wave rectifying or full-wave rectifying on the AC signal.

The power factor correction circuitry 230 may be configured to output a DC signal from the AC signal rectified by the rectifying circuitry 220. A capacitor 231 configured to (at least temporarily) store the AC signal rectified by the rectifying circuitry 220 may be disposed between the rectifying circuitry 220 and the power factor correction circuitry 230. The capacitor 231 may be charged by the rectifying circuitry 220. When the capacitor 231 is charged by the rectified AC signal, a voltage between both ends of the capacitor may be smoothen.

The power factor correction circuitry 230 may control charging of a capacitor 232 using a power charged by the capacitor 231. For example, the power factor correction circuitry 230 may control the charging of the capacitor 232 according to a threshold power factor (or a power factor greater than equal to the threshold power factor) defined by the power system 110 (or law). For example, the power factor correction circuitry 230 may be configured to control the charging of the capacitor 232 based on a power factor of the AC signal. The power factor correction circuitry 230 may be configured to charge the capacitor 232 using the power stored in the capacitor 231. Herein, a power factor (PF) may refer to a ratio between an active power and a reactive power included in an apparent power of the electronic device 101 with respect to the power system 110. The capacitors 231 and 232 may include, for example, and without limitation, an electrolytic capacitor, a tantalum capacitor, a ceramic capacitor, a film capacitor, or the like. The capacitors 231 and 232 may be referred to as a bulk capacitor and/or a super capacitor in terms of storing power for driving the electronic device 101.

The DC-DC correction circuitry 240 may be configured to generate a DC signal to be output from the power factor correction circuitry 230 or transmitted to a remaining electronic component (e.g., the main circuitry 180) different from the power circuitry 170 using electrical energy stored in the capacitor 232. For example, the DC-DC correction circuitry 240 may be configured to generate the DC signal based on the power charged in the capacitor 232. The electronic device 101 may include an electronic component configured to receive the DC signal of the DC-DC correction circuitry 240.

Referring to FIG. 2, an example in which a DC signal having a voltage Vckt is transmitted from the DC-DC correction circuitry 240 to the main circuitry 180 is illustrated. An optical coupler 290 may be disposed between the main circuitry 180 and the power circuitry 170. The optical coupler 290 may be configured to transmit information (e.g., power consumption of the main circuitry 180) for controlling the power factor and/or driving of the power circuitry 170, from the main circuitry 180 to the power circuitry 170 while maintaining electrical isolation between the main circuitry 180 and the power circuitry 170.

An example in which the main circuitry 180 and the DC-DC correction circuitry 240 are connected to the power factor correction circuitry 230 and/or the capacitor 232 is illustrated, but the disclosure is not limited thereto. For example, the power factor correction circuitry 230 and/or the capacitor 232 may be connected to the display panel 160 (or another DC-DC correction circuitry configured to provide a power signal to the display panel 160) of FIG. 1. For example, the DC-DC correction circuitry 240 and the other DC-DC correction circuitry may be connected in parallel with respect to the capacitor 232.

Referring to FIG. 2, the power circuitry 170 may include control circuitry 250 for controlling the transistor 222. The control circuitry 250 may be configured to generate a control signal to be transmitted to the transistor 222 using an AC signal. For example, in order to perform wave rectification by the rectifying circuitry 220, the control circuitry 250 may transmit the control signal to at least temporarily activate an electrical connection by the transistor 222, to the transistor 222. The control circuitry 250 may be configured to detect a voltage (e.g., at least one of nodes p+ and p-) applied to the rectifying circuitry 220.

In an embodiment, the control circuitry 250 that generates the control signal to be transmitted to the transistor 222 may be configured to operate based on a voltage of an AC signal applied to the nodes p+ and p-. In a case that noise is included in the AC signal, the control signal transmitted from the control circuitry 250 to the transistor 222 may also include the noise. According to an embodiment, the control circuitry 250 may include switching circuitry for preventing/reducing a malfunction (e.g., a malfunction by a parasitic capacitor of the transistor 222) of the transistor 222 when receiving an unstable AC signal (e.g., the AC signal including the noise). The control circuitry 250 and the switching circuitry may be referred to as protection circuitry (e.g., protection circuitry with respect to the rectifying circuitry 220).

Hereinafter, an example structure of the control circuitry 250 and the switching circuitry will be described as the protection circuitry with respect to the transistor 222 with reference to FIG. 3.

FIG. 3 is a circuit diagram illustrating example control circuitry 250 with respect to a transistor of rectifying circuitry 220-1 according to various embodiments. Referring to FIG. 3, an example circuit diagram of the control circuitry 250 and switching circuitry 310 connected to the rectifying circuitry 220-1, which is an example of the rectifying circuitry 220 of FIG. 2, is illustrated. The electronic device 101 and/or the power circuitry 170 of FIG. 1 and/or FIG. 2 may include the rectifying circuitry 220-1, the control circuitry 250, and the switching circuitry 310 of FIG. 3.

Referring to FIG. 3, as an example of the transistor 222 of FIG. 2, at least a portion of power circuitry (e.g., the power circuitry 170 of FIG. 1 and/or FIG. 2) including the rectifying circuitry 220-1 including two transistors 222-1 and 222-2 is illustrated. An AC signal of a power system 110 may be applied to nodes p+ and p- of the rectifying circuitry 220-1. The node p+ may be referred to as a live node, and the node p- may be referred to as a neutral node. The nodes p+ and p- of FIG. 3 may correspond to the nodes p+ and p- of FIG. 2, respectively. A port including the nodes p+ and p- may be connected to the EMI filter 210 of FIG. 2 and/or the plug 120 of FIG. 1. Through the port, the power circuitry (e.g., the power circuitry 170 of FIG. 1 and/or FIG. 2) may be configured to receive the AC signal. The transistor 222 configured to control transmission of the AC signal may be disposed on a power path extending from the port (or the nodes p+ and p- included in the port). Referring to FIG. 3, as an example of the transistor 222, the transistors 222-1 and 222-2 are illustrated on power paths extending from each of the nodes p+ and p-.

Referring to FIG. 3, as an example of a transistor included in the rectifying circuitry 220-1, the transistors 222-1 and 222-2, which are N-channel MOSFETs, are illustrated. The disclosure is not limited thereto, and the transistors 222-1 and 222-2 may be P-channel MOSFETs. A source electrode of the transistor 222 may be grounded. For example, source electrodes s1 and s2 of the transistors 222-1 and 222-2 may be connected to a ground node. A drain electrode of the transistor 222 may be connected to any one of the nodes p+ and p- of the port to which the AC signal is applied. For example, a drain electrode d1 of the transistor 222-1 may be connected to the node p+, and a drain electrode d2 of the transistor 222-2 may be connected to the node p-. An electrical connection between the source electrode and the drain electrode of the transistor 222 may be established or blocked according to a voltage of a control signal applied to a gate electrode.

Referring to FIG. 3, the rectifying circuitry 220-1 may include a diode 224 including an anode connected to the node p+ and a cathode connected to an end of a capacitor 231. The rectifying circuitry 220-1 may include a diode 225 including an anode connected to the node p- and a cathode connected to an end of the capacitor 231. The capacitor 231 of FIG. 3 may correspond to the capacitor 231 of FIG. 2.

Referring to FIG. 3, a signal path for transmission of the control signal may be established between the gate electrode of the transistor 222 and the control circuitry 250. The gate electrode of the transistor 222 may be connected to the signal path. Referring to FIG. 3, the control circuitry 250 for controlling the two transistors 222-1 and 222-2 may include two signal paths connected to each of gate electrodes g1 and g2 of the transistors 222-1 and 222-2. In the present disclosure, the signal path of the transistor 222-1 may refer to a signal path formed between the gate electrode g1 of the transistor 222-1 and the control circuitry 250, for control of the transistor 222-1. In the present disclosure, the signal path of the transistor 222-2 may refer to a signal path formed between the gate electrode g2 of the transistor 222-2 and the control circuitry 250, for control of the transistor 222-2.

Referring to FIG. 3, the control circuitry 250 may include circuitry for activating (e.g., turning on) or deactivating (e.g., turning off) the transistor 222 using an AC signal. For example, the control circuitry 250 may include a microcontroller unit (MCU) 320. At least a portion of the control circuitry 250 including the MCU 320 may be designed or produced as an integrated circuit (IC) and/or an application specific integrated circuit (ASIC). In the present disclosure, the MCU 320 may be referred to as a controller or processor. The control circuitry 250 configured to control the transistor 222 may generate a control signal to be transmitted to the gate electrode of the transistor 222 based on a voltage (e.g., at least one of voltages of the nodes p+ and p-) of the AC signal.

Referring to FIG. 3, nine nodes dp+, dp-, p+, p-, Q1, Q2, SQ1, SQ2, and F included in the MCU 320 of the control circuitry 250 are illustrated. The number of nodes included in the MCU 320 is not limited to what is illustrated in FIG. 3. The node p+ of the MCU 320 may be connected to the node p+ of the rectifying circuitry 220-1. The node p- of the MCU 320 may be connected to the node p- of the rectifying circuitry 220-1. The control circuitry 250 may include a capacitor 331 including an end connected to the node p+ (or the anode of the diode 224, or the drain electrode d1 of the transistor 222-1) of the rectifying circuitry 220-1 and another end connected to the node dp+ of the MCU 320. The control circuitry 250 may include a capacitor 332 including an end connected to the node p- (or the anode of the diode 225, or the drain electrode d2 of the transistor 222-2) of the rectifying circuitry 220-1 and another end connected to the node dp- of the MCU 320. A portion 330 of the control circuitry 250 including the capacitors 331 and 332 may be circuitry configured to measure rates of change of voltages of each of the nodes p+ and p-.

The control circuitry 250 may include an amplifier 351 including an output node (or an output terminal) connected to the gate electrode g1 of the transistor 222-1, and an input node (or an input terminal) connected to the node Q1 of the MCU 320. The control circuitry 250 may include an amplifier 352 including an output node (or an output terminal) connected to the gate electrode g2 of the transistor 222-2, and an input node (or an input terminal) connected to the node Q2 of the MCU 320. The control circuitry 250 may include a diode 341 including an anode connected to the gate electrode g1 (or a node 312 on a signal path of the transistor 222-1) of the transistor 222-1, and a cathode connected to the node SQ1 of the MCU 320. The control circuitry 250 may include a diode 342 including an anode connected to the gate electrode g2 (or a node 311 on a signal path of the transistor 222-2) of the transistor 222-2, and a cathode connected to the node SQ2 of the MCU 320. A portion 340 of the control circuitry 250 including the diodes 341 and 342 may be circuitry configured to measure voltages of each of the gate electrodes g1 and g2 of the transistors 222-1 and 222-2.

Referring to FIG. 3, the switching circuitry 310 configured to adjust the voltages of each of the gate electrodes g1 and g2 of the transistors 222-1 and 222-2, is illustrated. The switching circuitry 310 may be connected to the control circuitry 250 or may be included in the control circuitry 250. The switching circuitry 310 may include a diode 314 including an anode connected to the gate electrode g1 (or the node 312 on the signal path of the transistor 222-1) of the transistor 222-1. The switching circuitry 310 may include a diode 313 including an anode connected to the gate electrode g2 (or the node 311 on the signal path of the transistor 222-2) of the transistor 222-2. The switching circuitry 310 may include a transistor 315 including a drain electrode d3 connected to cathodes of the diodes 313 and 314, and a source electrode s3 connected to a ground node. A gate electrode g3 of the transistor 315 may be connected to the node F of the MCU 320.

In the disclosure, the control circuitry 250 may include any circuitry configured to control the transistors 222-1 and 222-2 included in the rectifying circuitry 220-1. For example, a term "control circuitry" may be used to refer to the MCU 320 as well as the control circuitry 250, and a combination of the control circuitry 250 and the switching circuitry 310 of FIG. 3. For example, not only the MCU 320 but also the control circuitry 250 and/or the switching circuitry 310 of FIG. 3 may be integrated in IC referred to as "control circuitry".

A transistor (e.g., the transistor 222 of FIG. 2) of the rectifying circuitry 220-1 including the transistors 222-1 and 222-2, may be configured to control an electrical connection between the port (e.g., the port including the nodes p+ and p-) for receiving an AC signal and the capacitor 231. The control circuitry 250 may be connected to a gate electrode (e.g., the gate electrodes g1 and g2) of a transistor (e.g., the transistors 222-1 and 222-2). The control circuitry 250 may activate any one transistor of the transistors 222-1 and 222-2, and deactivate another transistor, based on a polarity (e.g., a voltage of the node p+ with respect to the node p- that is the neutral node) of the AC signal received through the port. In a case that at least one voltage of the nodes p+ and p- exceeds a threshold (e.g., over voltage protection (OVP)), the control circuitry 250 may deactivate both the transistors 222-1 and 222-2. The control circuitry 250 may deactivate both the transistors 222-1 and 222-2 in a time section (e.g., a zero crossing section of the voltages of nodes p+ and p-) in which a phase of the AC signal received through the port changes.

For example, to activate a transistor, the control circuitry 250 may transmit a control signal having a voltage greater than or equal to a threshold voltage for an electrical connection between a drain electrode and a source electrode of the transistor, to a signal path of the transistor. For example, to activate the transistor 222-1, a voltage of the node Q1 of the MCU 320 may be amplified by the amplifier 351. The voltage (e.g., a voltage greater than or equal to a threshold voltage of the transistor 222-1) amplified by the amplifier 351 may be applied to the gate electrode g1 of the transistor 222-1. For example, in order to deactivate a transistor, the control circuitry 250 may transmit a control signal having a voltage less than the threshold voltage, to the signal path of the transistor. For example, to deactivate the transistor 222-1, a control signal having a voltage of substantially 0 V may be output from the node Q1 of the MCU 320.

In an embodiment, the switching circuitry 310 may be configured to connect the signal path to the ground node by being connected to a signal path between the gate electrode of the transistor and the control circuitry 250. The control circuitry 250 may be configured to conditionally control the switching circuitry 310 to transmit a control signal to be transmitted from the control circuitry 250 to the gate electrode through the signal path to the ground node, based on the voltage of the AC signal received through the port.

In an embodiment, the control circuitry 250 may control the switching circuitry 310 to protect the transistor (e.g., the transistors 222-1 and 222-2) of the rectifying circuitry 220-1 from noise of the AC signal applied to the nodes p+ and p-. For example, while a voltage of the AC signal is less than a threshold for OVP, the control circuitry 250 may control the switching circuitry 310 based on a rate of change (e.g., dv/dt) of the voltage. Referring to FIG. 3, the transistor 315 of the switching circuitry 310 may be configured to establish an electrical connection between the nodes 311 and 312 and the ground node while a voltage of the gate electrode g3 greater than a threshold voltage for driving the transistor 315. Since the gate electrode g3 is connected to the node F of the MCU 320, the transistor 315 may be configured to establish or release the electrical connection based on a control signal transmitted from the node F. While the electrical connection is established, a voltage of the nodes 311 and 312 may be reduced to a voltage (e.g., a reference voltage such as 0 V) of the ground node (e.g., pull-down). In terms of reducing the voltage of the nodes 311 and 312, the switching circuitry 310 may be referred to as pull-down circuitry. While the electrical connection is released, the voltage of the nodes 311 and 312 may have a different voltage (e.g., voltages of the output node of the amplifiers 351 and 352) from the ground node.

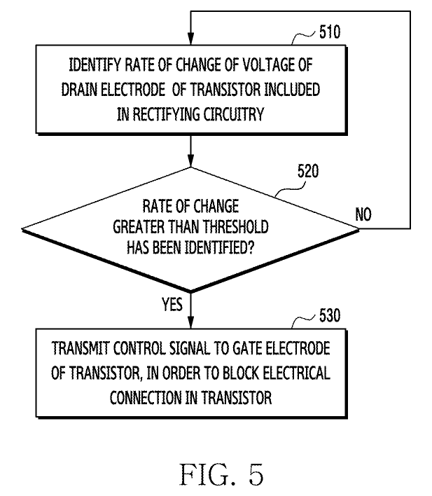

In an embodiment, the MCU 320 may be configured to measure the rate of change of the voltage of the AC signal (e.g., the AC signal applied to the nodes p+ and p-) received through the rectifying circuitry 220-1 through the capacitors 331 and 332. The MCU 320 may identify or measure a rate of change of a voltage of the node p+ and a rate of change of a voltage of the node p- through each of the nodes dp+ and dp- connected to the capacitors 331 and 332, respectively. Based on the identified rate of change, the MCU 320 may determine a voltage of a control signal to be transmitted to the gate electrode g3 of the transistor 315 through the node F. An operation of the MCU 320 based on the rate of change of the voltage of the AC signal identified through the nodes dp+ and dp- will be described with in greater detail below with reference to FIGS. 5 and/or 6 .

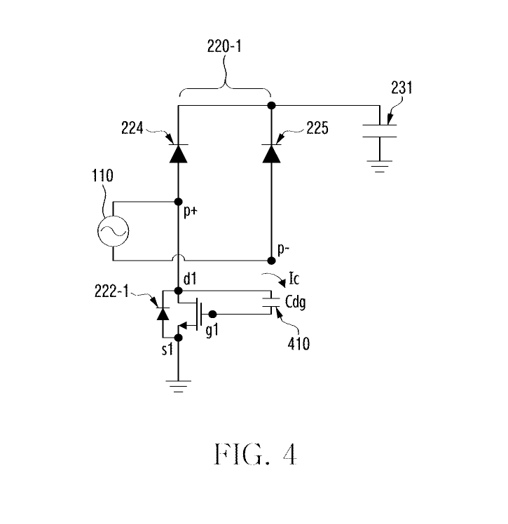

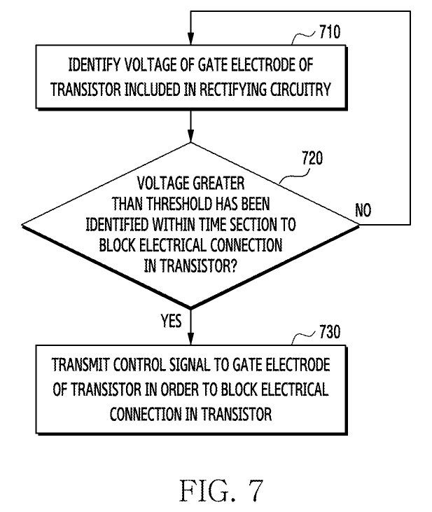

In an embodiment, the MCU 320 of the control circuitry 250 may monitor a voltage of the gate electrode g1 of the transistor 222-1 through the node SQ1. The MCU 320 may monitor a voltage of the gate electrode g2 of the transistor 222-2 through the node SQ2. The voltages of the gate electrodes g1 and g2 of the transistors 222-1 and 222-2 may be abnormally increased based on a parasitic capacitor, as described later with reference to FIG. 4. In a case that at least one of the voltages of the gate electrodes g1 and g2 is abnormally increased, the MCU 320 may increase the voltage of the control signal to be transmitted to the gate electrode g3 of the transistor 315 through the node F, to a voltage greater than or equal to a threshold for driving the transistor 315. An operation of the MCU 320 based on the voltages of the gate electrodes g1 and g2 identified through the nodes SQ1 and SQ2 will be described in greater detail below with reference to FIGS. 7 and/or 8 .

As described above, the control circuitry 250 may generate or output one or more control signals (e.g., control signals transmitted through each of nodes Q1 and Q2) for control of the transistor (e.g., the transistors 222-1 and 222-2) of the rectifying circuitry 220-1. The control circuitry 250, together with the one or more control signals, may generate or output another control signal (e.g., a control signal transmitted through the node F) for control of the switching circuitry 310. The other control signal may be transmitted to the gate electrode g3 of the transistor 315 in the switching circuitry 310. The other control signal transmitted to the switching circuitry 310 may be generated to activate the transistor 315 in response to a rapid change (e.g., a rapid increase and/or a rapid decrease) of the voltage of the AC signal input to the rectifying circuitry 220-1, and/or an unstable change such as chattering. The other control signal transmitted to the switching circuitry 310 may be configured to activate the transistor 315 in the switching circuitry 310 to reduce or prevent damage (e.g., damage by a shoot through current) to the transistor (e.g., the transistors 222-1 and 222-2) of the rectifying circuitry 220-1.

Hereinafter, an example case in which the transistor (e.g., the transistors 222-1 and 222-2) of the rectifying circuitry 220-1 are damaged will be described in greater detail with reference to FIG. 4.

FIG. 4 is an example circuit diagram illustrating a relationship between noise of an alternate current signal and a voltage of a gate electrode g1 of a transistor 222-1 according to various embodiments. Referring to FIG. 4, a portion of the rectifying circuitry 220-1 of FIG. 3 is illustrated. Diodes 224 and 225 of FIG. 4 and the transistor 222-1 may correspond to the diodes 224 and 225 and the transistor 222-1 included in the rectifying circuitry 220-1 of FIG. 3, respectively. Referring to FIG. 4, an example case in which the transistor 222-1 is damaged is described, but another transistor (e.g., the transistor 222-2 of FIG. 3) of the rectifying circuitry 220-1 may also be similarly damaged.

Referring to FIG. 4, a capacitor 410 including an end connected to a drain electrode d1 of the transistor 222-1 and another end connected to the gate electrode g1 of the transistor 222-1, may indicate parasitic capacitance formed in the transistor 222-1. For example, the capacitor 410 may be an imaginary circuit element illustrated to explain an operation of the transistor 222-1 based on parasitic capacitance Cdg between the drain electrode d1 and the gate electrode g1 of the transistor 222-1.

By the capacitor 410 having the parasitic capacitance Cdg, a voltage of the gate electrode g1 of the transistor 222-1 may be changed without a control signal provided from control circuitry (e.g., the control circuitry 250 of FIG. 2 and/or FIG. 3) connected to the gate electrode g1. For example, in a case that a voltage of an AC signal applied to a node p+ connected to the drain electrode d1 of the transistor 222-1 increases rapidly (e.g., a rapid increase based on noise), the voltage of the gate electrode g1 of the transistor 222-1 may increase by the capacitor 410. For example, the voltage of the gate electrode g1 may increase as much as a rate of change dv/dt of the voltage of the AC signal applied to the node p+ by the capacitor 410. As the voltage (e.g., the voltage of the AC signal) of the node p+ changes rapidly, the voltage of the gate electrode g1 may also increase rapidly (e.g., spike). The rapid change of the voltage of the gate electrode g1 may cause damage to the transistor 222-1. A phenomenon in which the voltage of the gate electrode g1 rapidly increases according to the change of the drain electrode d1 based on the parasitic capacitance (e.g., the capacitor 410) may be referred to as a Miller effect.

The voltage of the gate electrode g1 increased by the Miller effect may increase a potential difference between the gate electrode g1 and the source electrode s1 of the transistor 222-1. When the potential difference is greater than the absolute maximum rating of the transistor 222-1, the transistor 222-1 may be damaged. In a case that the transistor 222-1 is damaged, it may cause a (permanent) cessation of a rectification operation by the transistor 222-1. In other words, the damage to the transistor 222-1 may cause deactivation of the rectifying circuitry 220-1 including the transistor 222-1 and load circuitry (e.g., a remaining portion connected to rectifying circuitry 220-1 in the power circuitry 170 of FIG. 2, the main circuitry 180 of FIG. 1, and/or the display panel 160 of FIG. 1) connected to the rectifying circuitry 220-1.

According to an embodiment, the control circuitry (e.g., the control circuitry 250 of FIGS. 2 to 3) of the rectifying circuitry 220-1 may (conditionally) establish an electrical connection between the gate electrode g1 and the ground node to prevent/reduce an abnormal increase in the voltage of the gate electrode g1 of the transistor 222-1. For example, the control circuitry may include pull-down circuitry (e.g., the switching circuitry 310 of FIG. 3) for reducing the voltage of the gate electrode g1 to a voltage of the ground node. The control circuitry may determine whether to establish the electrical connection using the voltage of the gate electrode g1 and/or the drain electrode d1 (or the node p+) of the transistor 222-1.

Hereinafter, an example operation of the control circuitry to establish or release the electrical connection based on the voltage of the drain electrode d1 of the transistor 222-1 will be described in greater detail with reference to FIG. 5.

FIG. 5 is a flowchart illustrating an example operation of control circuitry associated with a voltage of an alternate current signal according to various embodiments. The control circuit 250 of FIG. 2 and/or FIG. 3 may perform an operation of the control circuitry described with reference to FIG. 5. The operation of the control circuitry of FIG. 5 may be performed by the control circuitry 250 and/or the MCU 320 of FIG. 3. For example, in the MCU 320 of FIG. 3, a set (e.g., a program referred to as firmware) of instructions configured to perform the operation of FIG. 5 may be installed.

Referring to FIG. 5, in operation 510, the control circuitry according to an embodiment may identify a rate of change of a voltage of a drain electrode (e.g., the drain electrodes d1 and d2 of FIG. 3) of a transistor (e.g., the transistor 222 of FIG. 2 and/or the transistors 222-1and 222-2 of FIG. 3) included in rectifying circuitry (e.g., the rectifying circuitry 220 of FIG. 2 and/or the rectifying circuitry 220-1 of FIG. 3). For example, the control circuitry may identify or detect the rate of change of the drain electrodes d1 and d2 of FIG. 3, by measuring voltages of the nodes dp+ and dp- respectively connected to the capacitors 331 and 332 of FIG. 3. An embodiment of measuring the rate of change of all voltages of the nodes dp+ and dp- of FIG. 3 has been described, but the disclosure is not limited thereto, and the control circuitry may identify or calculate at least one of the rate of change of the voltages of the nodes dp+ and dp- of FIG. 3.

Referring to FIG. 5, in operation 520, the control circuitry according to an embodiment may determine or check whether the rate of change greater than a threshold has been identified. While identifying the rate of change less than or equal to (or less than) the threshold (520-NO), the control circuitry may (continuously, repeatedly, and/or periodically) perform operation 510. In a case of identifying the rate of change greater than (or greater than or equal to) the threshold (520-YES), the control circuitry may perform operation 530. The rate of change of the drain electrode of the transistor in operation 510 may cause a rapid change of a voltage of a gate electrode, as described above with reference to FIG. 4. When the rate of change of operation 510 is greater than the threshold, the voltage of the gate electrode may be rapidly increased.

Referring to FIG. 5, in operation 530, the control circuitry according to an embodiment may transmit a control signal to the gate electrode of the transistor, to block an electrical connection in the transistor. For example, the control circuitry may control switching circuitry (e.g., the switching circuitry 310 of FIG. 3) to transmit the control signal to be transmitted from the control circuitry to the gate electrode of the transistor through a signal path, to the ground node, based on identifying the rate of change greater than a threshold rate of change. For example, the control circuitry may reduce the voltage of the gate electrode of the transistor of the rectifying circuitry to a voltage of the ground node. Since the voltage of the gate electrode is reduced to the voltage of the ground node, which is a voltage less than a threshold voltage for driving the transistor, the electrical connection in the transistor may be blocked.

As described above, the control circuitry according to an embodiment may reduce the voltage of the gate electrode to the voltage of the ground node when a condition of rapidly increasing the voltage of the gate electrode of the transistor is satisfied. For example, the control circuitry may operate as protection circuitry to prevent/reduce a rapid increase of the voltage of the gate electrode. Since a voltage of an AC signal is applied to the drain electrode of the transistor included in the rectifying circuitry, the control circuitry performing the operation of FIG. 5 may protect the transistor despite a rapid change of the voltage of the AC signal.

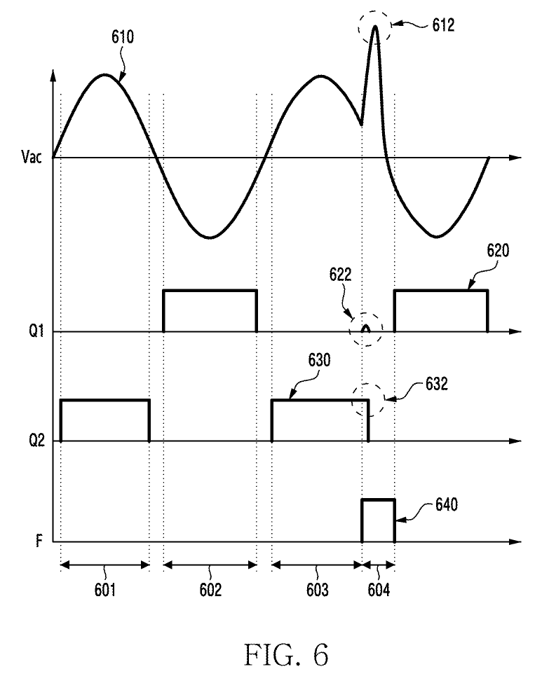

Hereinafter, the voltage of the gate electrode of the transistor in the rectifying circuitry will be described in an example case in which the voltage of the AC signal is rapidly changed with reference to FIG. 6.

FIG. 6 is a graph illustrating an example operation of control circuitry based on noise of an alternate current signal according to various embodiments. Referring to FIG. 6, graphs 610, 620, 630, and 640 indicated along a matched time axis are illustrated. The control circuitry 250 of FIG. 2 and/or FIG. 3 may include the control circuitry of FIG. 6. The graph 610 may indicate a voltage of the AC signal received by rectifying circuitry (e.g., the rectifying circuitry 220-1 of FIG. 3) connected to the control circuitry. For example, a voltage at the node p+ of FIG. 3 may be indicated as the graph 610. The graph 620 may indicate a voltage of a gate electrode g1 of a first transistor (e.g., the transistor 222-1 of FIG. 3) of the rectifying circuitry (e.g., the rectifying circuitry 220-1 of FIG. 3) connected to the control circuitry. The graph 630 may indicate a voltage of a gate electrode g2 of a second transistor (e.g., the transistor 222-2 of FIG. 3) of the rectifying circuitry (e.g., the rectifying circuitry 220-1 of FIG. 3) connected to the control circuitry. The graph 640 may indicate a voltage of a control signal (e.g., the control signal transmitted to the transistor 315 in the switching circuitry 310 through the node F of FIG. 3) transmitted to switching circuitry (e.g., the switching circuitry 310 of FIG. 3).

Referring to the graph 610, within a time section 601 in which a voltage of the node p+ of FIG. 3 is positive, the voltage of the gate electrode g2 of the transistor 222-2 of FIG. 3 indicated by the graph 630 may be increased to a voltage greater than or equal to a threshold for driving the transistor 222-2. Within the time section 601, the voltage of the gate electrode g1 of the transistor 222-1 of FIG. 3, indicated by the graph 620, may be maintained at a voltage (e.g., a voltage of substantially 0 V) less than the threshold for driving the transistor 222-1. Within the time section 601, the transistor 222-2 among the transistors 222-1 and 222-2 of FIG. 3 may be activated.

Since the transistor 222-2 of FIG. 3 is activated and the transistor 222-1 is deactivated within the time section 601, the voltage of the node p+ may be applied to a capacitor 231 through the diode 224 of FIG. 3. For example, within the time section 601, the AC signal may be transmitted to the capacitor 231 through the node p+ and the diode 224 of FIG. 3.

Referring to the graph 610, within a time section 602 in which the voltage of the node p+ of FIG. 3 is negative, the voltage of the gate electrode g1 of the transistor 222-1 of FIG. 3, indicated by the graph 620, may be increased to a voltage greater than or equal to the threshold for driving the transistor 222-1. Within the time section 602, the voltage of the gate electrode g2 of the transistor 222-2 of FIG. 3, indicated by the graph 630, may be maintained at a voltage (e.g., the voltage of substantially 0 V) less than the threshold for driving the transistor 222-2. Within the time section 602, the transistor 222-1 among the transistors 222-1 and 222-2 of FIG. 3 may be activated.

Since the transistor 222-1 of FIG. 3 is activated and the transistor 222-2 is deactivated within the time section 602, a voltage of the node p- may be applied to the capacitor 231 through the diode 225 of FIG. 3. For example, within the time section 602, the AC signal may be transmitted to the capacitor 231 through the node p- and the diode 225 of FIG. 3.

Referring to the graph 610, a time section between the time sections 601 and 602 may be a zero crossing section of the voltage of the AC signal. Within the zero crossing section, all of the voltages of the gate electrodes g1 and g2 of the transistors 222-1 and 222-2 of FIG. 3, indicated by the graphs 620 and 630, may be maintained at a voltage less than the threshold for driving the transistors 222-1 and 222-2. For example, within the zero crossing section, both transistors 222-1 and 222-2 of FIG. 3 may be deactivated.

Referring to FIG. 6, within a time section 603, similar to the time section 601, the voltage of the gate electrode g2 of the transistor 222-2 of FIG. 3, indicated by the graph 630, may be maintained at a voltage greater than the threshold for driving the transistor 222-2. Referring to FIG. 6, it is assumed that noise 612 is included in the voltage of the node p+ of FIG. 3, indicated by the graph 610, within a time section 604 after the time section 603. The noise 612 may cause a rapid change of the voltage of the node p+.

As described above with reference to FIGS. 3 to 5, the control circuitry may generate or output a control signal that causes turn-off of at least one transistor in the rectifying circuitry based on the rate of change of the voltage of the AC signal indicated by the graph 610. For example, within the time section 604, the control circuitry may change a voltage of the control signal transmitted to the switching circuitry, indicated by the graph 640, to a voltage greater than the threshold for driving the transistor (e.g., the transistor 315 of FIG. 3) in the switching circuitry. As described above with reference to FIG. 3, when the transistor in the switching circuitry is activated based on the voltage indicated by the graph 640, the voltage of the gate electrode of at least one transistor in the rectifying circuitry may be reduced to less than the threshold for driving the at least one transistor. For example, the voltages of the transistors 222-1 and 222-2 of FIG. 3, indicated by the graphs 620 and 630, may be substantially reduced to 0 V. In the example, within the time section 604, the transistors 222-1 and 222-2 of FIG. 3 may be deactivated (e.g., turn-off).

Since the voltage of the gate electrode of the at least one transistor in the rectifying circuitry is substantially reduced to 0 V within the time section 604, a rapid increase of the voltage of the gate electrode due to the noise 612 may be prevented/reduced. Referring to the graph 620, noise 622 of the voltage of the gate electrode g1 of the transistor 222-1 of FIG. 3, caused by the noise 612 of the AC signal, may have a size less than that of the noise 612, since the voltage of the gate electrode g1 is substantially reduced to 0 V. Similarly, referring to the graph 630, noise 632 of the voltage of the gate electrode g2 of the transistor 222-2 of FIG. 3, caused by the noise 612 of the AC signal, may be removed without the rapid increase due to the noise 612, since the voltage of the gate electrode g2 is substantially reduced to 0 V within the time section 604.

Hereinafter, an example operation of the control circuitry that establishes or releases an electrical connection between the gate electrode and the ground node by (directly) monitoring the voltage of the gate electrode of the transistor in the rectifying circuitry will be described in greater detail with reference to FIG. 7.

FIG. 7 is a flowchart illustrating an example operation of control circuitry associated with a voltage of a gate electrode of a transistor in rectifying circuitry according to various embodiments. The control circuitry 250 of FIG. 2 and/or FIG. 3 may perform the operation of the control circuitry described with reference to FIG. 7. The operation of the control circuitry of FIG. 7 may be performed by the control circuitry 250 and/or the MCU 320 of FIG. 3. For example, within the MCU 320 of FIG. 3, a set (e.g., a program referred to as firmware) of instructions configured to perform the operation of FIG. 7 may be installed. The operation of FIG. 5 and/or FIG. 7 may be performed based on different circuitry from the control circuitry 250 and/or the MCU 320 of FIG. 3.

Referring to FIG. 7, in operation 710, the control circuitry according to an embodiment may identify the voltage of the gate electrode (e.g., the gate electrodes g1 and g2 of FIG. 3) of the transistor (e.g., the transistors 222-1 and 222-2 of FIG. 3) included in the rectifying circuitry (e.g., the rectifying circuitry 220 of FIG. 2 and/or the rectifying circuitry 220-1 of FIG. 3). For example, through each of the nodes SQ1 and SQ2 connected to the cathodes of the diodes 341 and 342 of FIG. 3, the control circuitry may identify or detect voltages of signal paths of the transistors 222-1 and 222-2 included in the rectifying circuitry. The control circuitry may perform operation 710 while controlling the transistor in the rectifying circuitry for rectification of an AC signal based on the rectifying circuitry.

Referring to FIG. 7, in operation 720, the control circuitry according to an embodiment may determine or check whether a voltage greater than a threshold has been identified within a time section to block an electrical connection in the transistor. In a case that the rectifying circuitry includes a plurality of transistors, the control circuitry may alternately activate or deactivate the plurality of transistors. The threshold of operation 720 may be a threshold for activating the transistor in the rectifying circuitry (e.g., for establishing an electrical connection between a drain electrode and a source electrode).

For example, in a case of identifying a voltage less than (or less than or equal to) the threshold within a time section to deactivate the transistor of operation 710 and/or within the time section to block the electrical connection (e.g., the electrical connection between the drain electrode and the source electrode) in the transistor (720-NO), the control circuitry may (continuously, repeatedly, and/or periodically) perform operation 710. For example, in a case of identifying a voltage greater than (or greater than or equal to) the threshold within a time section to activate the transistor of operation 710 and/or within the time section to block the electrical connection (e.g., the electrical connection between the drain electrode and the source electrode) in the transistor (720-YES), the control circuitry may perform operation 730.

Referring to FIG. 7, in operation 730, the control circuitry according to an embodiment may transmit a control signal to the gate electrode of the transistor in order to block the electrical connection in the transistor. For example, based on identifying a voltage of a signal path of the transistor greater than the threshold of operation 720 within a time section for releasing an electrical connection between a port (e.g., a port including the nodes p+ and p- of FIG. 2 and/or FIG. 3) and a capacitor (e.g., the capacitor 231 of FIG. 2 and/or FIG. 3) based on the transistor in the rectifying circuitry, the control circuitry may control switching circuitry (e.g., the switching circuitry 310 of FIG. 3) to change the voltage of the signal path to a voltage of the ground node.

In an embodiment, the control signal of operation 730 may be transmitted to the switching circuitry (e.g., the switching circuitry 310 of FIG. 3) to transmit a control signal to be transmitted from the control circuitry to the gate electrode of the transistor through the signal path, to the ground node. The switching circuitry may electrically connect the gate electrode and the ground node of the transistor of operation 710 based on receiving the control signal of operation 730. Since it is electrically connected to the ground node, the voltage of the gate electrode of the transistor may be substantially reduced to 0 V. Since the voltage of the gate electrode of the transistor is substantially reduced to 0 V, the electrical connection (e.g., the electrical connection between the drain electrode and the source electrode of the transistor) in the transistor may be released or blocked.

As described above, the control circuitry according to an embodiment may block the electrical connection and/or reduce the voltage of the gate electrode of the transistor in a case that the voltage of the gate electrode of the transistor increases abnormally within the time section to block the electrical connection in the transistor (e.g., an increase based on the Miller effect described with reference to FIG. 4). For example, the control circuitry may operate as protection circuitry to prevent/reduce the voltage of the gate electrode of the transistor from increasing abnormally within the time section. In order to electrically connect the gate electrode and the ground node, the control circuitry may prevent/reduce an increase in the voltage of the gate electrode.

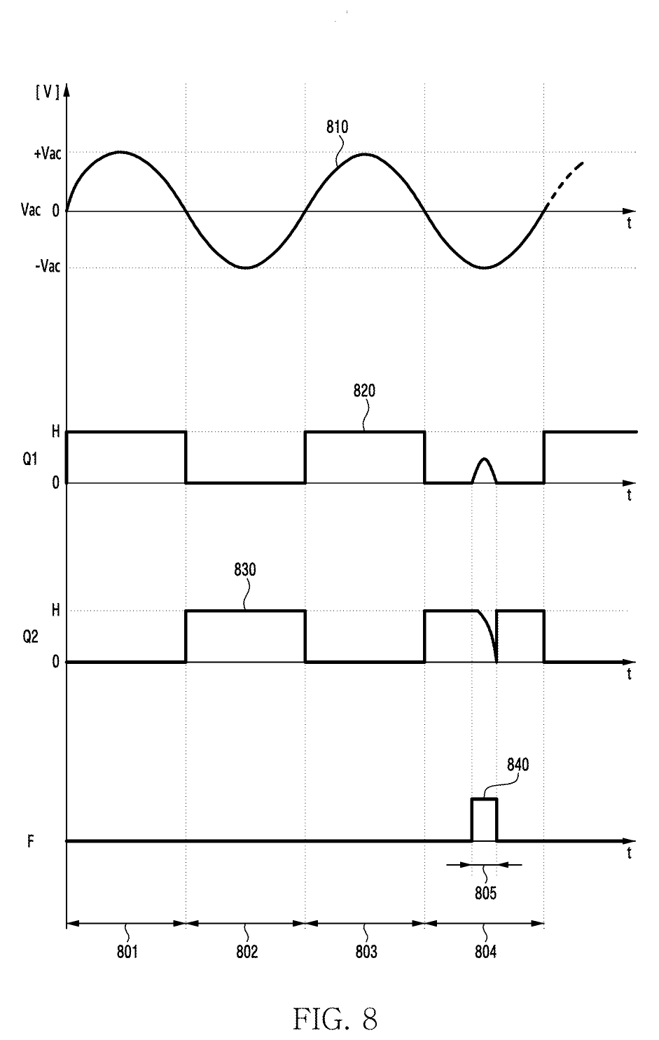

Hereinafter, an example operation of the control circuitry with respect to the transistor is described in an example case in which the gate electrode of the transistor in the rectifying circuitry increases within the time section to deactivate the transistor with reference to FIG. 8.

FIG. 8 is a graph illustrating an example operation of control circuitry based on a voltage of a gate electrode of a transistor in rectifying circuitry according to various embodiments. Referring to FIG. 8, graphs 810, 820, 830, and 840 indicated along a matched time axis are illustrated. The control circuitry 250 of FIG. 2 and/or FIG. 3 may include the control circuitry of FIG. 6. The graph 810 may indicate a voltage (e.g., a voltage at the node p+ of FIG. 3) of an AC signal received by the rectifying circuitry (e.g., the rectifying circuitry 220-1 of FIG. 3) connected to the control circuitry. The graph 820 may indicate a voltage of the gate electrode g2 of the transistor 222-2 of FIG. 3. The graph 830 may indicate a voltage of the gate electrode g1 of the transistor 222-1 of FIG. 3. The graph 840 may represent a voltage of a control signal (e.g., a control signal transmitted to the transistor 315 in the switching circuitry 310 through the node F of FIG. 3) transmitted to the switching circuitry 310 of FIG. 3.

Referring to the graph 810, a voltage of the node p+ of FIG. 3 may be positive in time sections 801 and 803, and may be negative in time sections 802 and 804. Referring to the graphs 820 and 830 in the time sections 801 and 803, the voltage of the gate electrode g2 of the transistor 222-2 among the transistors 222-1 and 222-2 of FIG. 3 may be increased to be greater than or equal to a threshold. For example, in the time sections 801 and 803, the transistor 222-2 of FIG. 3 may be activated and the transistor 222-1 may be deactivated. Referring to the graphs 820 and 830 in the time sections 802 and 804, the voltage of the gate electrode g1 of the transistor 222-1 among the transistors 222-1 and 222-2 of FIG. 3 may be increased to be greater than or equal to the threshold. For example, in the time sections 802 and 804, the transistor 222-1 of FIG. 3 may be activated and the transistor 222-2 may be deactivated. An operation of the control circuitry and the rectifying circuitry in the time section 801 may correspond to the operation of the control circuitry and the rectifying circuitry in the time section 601 of FIG. 6. An operation of the control circuitry and the rectifying circuitry in the time section 802 may correspond to the operation of the control circuitry and the rectifying circuitry in the time section 602 of FIG. 6.

Referring to FIG. 8, in the time sections 801 and 803, the control circuitry may activate the transistor 222-2 and deactivate the transistor 222-1 among the transistors 222-1 and 222-2 of FIG. 3. In other words, the time sections 801 and 803 may be set to activate the transistor 222-2 and deactivate the transistor 222-1. The time sections 802 and 804 may be set to deactivate the transistor 222-2 and activate the transistor 222-1.

Referring to the graph 820 of FIG. 8, within a time section 805 included in the time section 804, the voltage of the gate electrode g2 of the transistor 222-2 of FIG. 3 may be abnormally changed. For example, within the time section 804 set to deactivate the transistor 222-2 of FIG. 3, based on identifying a voltage increased to be greater than the threshold, the control circuitry may change the voltage of the control signal transmitted to the switching circuitry, such as the graph 840, to the voltage greater than the threshold for driving the transistor (e.g., the transistor 315 of FIG. 3) in the switching circuitry. Based on receiving the control signal, such as the graph 840, within the time section 805, the switching circuitry may connect the gate electrode (e.g., the gate electrode g2 of FIG. 3) of the transistor (e.g., the transistor 222-2 of FIG. 3) in the rectifying circuitry to the ground node. Referring to the graphs 820 and 830 within the time section 805, the voltages of the gate electrodes g1 and g2 of the transistors 222-1 and 222-2 of FIG. 3 may be reduced to the voltage (e.g., about 0 V) of the ground node.

FIG. 9 is circuit diagram illustrating example rectifying circuitry 220-2 connected to control circuitry according to various embodiments. Referring to FIG. 9, the rectifying circuitry 220-2, which is an example of the rectifying circuitry 220 of FIG. 2, is illustrated together with control circuitry 250 and switching circuitry 310 connected to the rectifying circuitry 220-2. The electronic device 101 and/or the power circuitry 170 of FIG. 1 and/or FIG. 2 may include the rectifying circuitry 220-2, the control circuitry 250, and the switching circuitry 310 of FIG. 9. The control circuitry 250 and the switching circuitry 310 of FIG. 9 may perform the operations described with reference to FIGS. 3 to 8.

Referring to FIG. 9, as an example of the transistor 222 of FIG. 2, at least a portion of power circuitry (e.g., the power circuitry 170 of FIG. 1 and/or FIG. 2) including the rectifying circuitry 220-2 including four transistors 221-1, 222-2, 222-3, and 222-4 is illustrated. Nodes p+ and p- of FIG. 9 may correspond to the nodes p+ and p- of FIG. 2 and/or FIG. 3. An embodiment in which the transistors 222-1, 222-2, 222-3, and 222-4 are N-channel MOSFETs is illustrated, but the disclosure is not limited thereto, and the transistors 222-1, 222-2, 222-3, and 222-4 may be P-channel MOSFETs. The transistors 222-1 and 222-2 of FIG. 9 may correspond to the transistors 222-1 and 222-2 of FIG. 3.

Referring to FIG. 9, the rectifying circuitry 220-2 may be connected to a capacitor 231. The capacitor 231 of FIG. 9 may correspond to the capacitor 231 of FIG. 2 and/or FIG. 3. The rectifying circuitry 220-2 of FIG. 9 may include the transistor 222-4 including a source electrode sb connected to the node p+ (or a drain electrode d1 of the transistor 222-1) and a drain electrode db connected to an end of the capacitor 231. The rectifying circuitry 220-2 of FIG. 9 may include the transistor 222-3 including a source electrode sa connected to the node p- (or a drain electrode d2 of the transistor 222-2) and a drain electrode da connected to an end of the capacitor 231.

The control circuitry 250, MCU 320, and the switching circuitry 310 of FIG. 9 may correspond to the control circuitry 250, the MCU 320, and the switching circuitry 310 of FIG. 3, respectively. Among descriptions of the control circuitry 250, the MCU 320, and the switching circuitry 310 of FIG. 9, an overlapping description of the control circuitry 250, the MCU 320, and the switching circuitry 310 of FIG. 3 may not be repeated here. Referring to FIG. 9, the control circuitry 250 may be configured to transmit control signals to the gate electrodes g1 and g2 of the transistors 222-1 and 222-2, based on voltages of the drain electrodes d1 and d2 of the transistors 222-1 and 222-2. Referring to FIG. 9, a signal path between the gate electrode g1 of the transistor 222-1 and the control circuitry 250 may extend to a gate electrode ga of the transistor 222-3. Referring to FIG. 9, a signal path between the gate electrode g2 of the transistor 222-2 and the control circuitry 250 may be connected to a gate electrode gb of the transistor 222-4. For example, the transistors 222-1 and 222-3 may be simultaneously activated or deactivated by a control signal output from a node Q1 of the MCU 320. For example, the transistors 222-2 and 222-4 may be simultaneously activated or deactivated by a control signal output from a node Q2 of the MCU 320. As described above with reference to FIGS. 6 and/or 8, the control circuitry 250 may alternately activate a first set of the transistors 222-1 and 222-3 and a second set of the transistors 222-2 and 222-4, based on the voltage of the AC signal.

According to an embodiment, the switching circuitry 310 may be connected to signal paths between the gate electrodes g1, g2, ga, gb of the transistors 222-1, 222-2, 222-3, and 222-4 and the control circuitry 250 to change the voltages of the gate electrodes g1, g2, ga, and gb to a voltage of a ground node. The control circuitry 250 may be configured to control the switching circuitry 310 based on whether a rate of change of at least one voltage of the drain electrodes d1 and d2 of the transistors 222-1 and 222-2 is greater than a threshold rate of change. The control circuitry 250 may control the switching circuitry 310 based on an AC component (e.g., a different AC component from an AC component provided by a power system 110, such as noise 612) of the voltage of the drain electrodes d1 and d2 of the transistors 222-1 and 222-2. In a case that the rate of change of at least one voltage of the drain electrodes d1 and d2 of the transistors 222-1 and 222-2 is greater than the threshold rate of change, the control circuitry 250 may transmit a control signal for establishing an electrical connection between a drain electrode d3 and a source electrode s3 of a transistor 315 in the switching circuitry 310, to the switching circuitry 310.

According to an embodiment, the control circuitry 250 may be configured to control the switching circuitry 310 using voltages of the signal paths of the transistors 222-1, 222-2, 222-3, and 222-4. For example, in a case that a voltage of a signal path of a specific transistor is greater than a threshold voltage within a second time section different from a first time section defined to activate the specific transistor for rectifying the AC signal based on the rectifying circuitry 220-2, the control circuitry 250 may reduce the voltage of the signal path of the specific transistor to the voltage of the ground node, by controlling the switching circuitry 310. For example, in a case that a voltage on a signal path connected to the gate electrodes g1 and ga of the transistors 222-1 and 222-3 is greater than the threshold voltage in the second time section different from the first time section defined to activate the first set of the transistors 222-1 and 222-3, the control circuitry 250 may reduce the voltages of the gate electrodes g1 and ga to the voltage of the ground node by controlling the switching circuitry 310. In an example, the second set of the transistors 222-2 and 222-4 may be set to be deactivated in the first time section. In the example, in a case that a voltage (e.g., a voltage of a node 311) on a signal path connected to the gate electrodes g2 and gb of the transistors 222-2 and 222-4 is greater than the threshold voltage in the first time section, the control circuitry 250 may change the voltages of the gate electrodes g2 and gb to the voltage of the ground node by controlling the switching circuitry 310. Referring to FIG. 9, when the transistor 315 of the switching circuitry 310 is activated, all of the gate electrodes g1, g2, ga, and gb of the transistors 222-1, 222-2, 222-3, and 222-4 included in the rectifying circuitry 220-2 may be electrically connected to the ground node.

As described above, the control circuitry 250 according to an embodiment may collectively reduce the voltages of the gate electrodes g1, g2, ga, and gb of the transistors 222-1, 222-2, 222-3, and 223-4 included in the rectifying circuitry 220-2 using the switching circuitry 310. When the voltages of the gate electrodes g1, g2, ga, and gb are simultaneously reduced by the switching circuitry 310, all of the transistors 222-1, 222-2, 222-3, and 222-4 may be deactivated. The control circuitry 250 may determine whether to control the switching circuitry 310 by checking a condition in which at least one of the voltages of the gate electrodes g1, g2, ga, and gb increases abnormally. For example, in a case that noise included in the voltage of the AC signal is identified, or at least one of the voltages of the gate electrodes g1, g2, ga, and gb increases abnormally, the control circuitry 250 may connect the at least one of the gate electrodes g1, g2, ga, and gb to the ground node, by controlling the switching circuitry 310.

In an example embodiment, a method of preventing/reducing noise of an alternate current signal from being transmitted to a transistor included in rectifying circuitry may be required. As described above, an electronic device (e.g., the electronic device 101 of FIG. 1) according to an example embodiment may comprise a port to receive an alternate current signal, a capacitor (e.g., the capacitor 231 of FIG. 2), a transistor (e.g., the transistors 222-1 and 222-2 of FIG. 3, and/or the transistors 222-1, 222-2, 222-3, and 222-4 of FIG. 9) configured to control an electric connection between the port and the capacitor, control circuitry (e.g., the control circuitry 250 of FIG. 2, 3 and/or FIG. 9) connected to a gate electrode of the transistor, and switching circuitry (e.g., the switching circuitry 310 of FIG. 3 and/or FIG. 9) , that is coupled to a signal path between the gate electrode and the control circuitry, configured to connect the signal path to a ground node. The control circuitry may be configured to control, based on a voltage of the alternate current signal received through the port, the switching circuitry to transmit, to the ground node, a control signal to be transmitted to the gate electrode from the control circuitry through the signal path. The electronic device according to an embodiment may comprise the control circuitry and/or the switching circuitry, configured to prevent/reduce the noise of the alternate current signal from being transmitted to the transistor included in the rectifying circuitry.

For example, the electronic device may comprise a diode (e.g., the diodes 224 and 225 of FIG. 3) including an anode connected to the port and a cathode connected to the capacitor. The transistor may include a drain electrode connected to the anode of the diode and a source electrode connected to the ground node.

For example, the capacitor may be a first capacitor. The electronic device may comprise a second capacitor (e.g., the capacitors 331 and 332 of FIG. 3 and/or FIG. 9) including an end connected to the anode of the diode and another end connected to the control circuitry.

For example, the control circuitry may be configured to identify a rate of change of the voltage of the alternate current signal through the second capacitor. The control circuitry may be configured to, based on identifying the rate of change greater than a threshold rate of change, control the switching circuitry to transmit a control signal to be transmitted to the gate electrode from the control circuitry through the signal path, to the ground node.

For example, the transistor may be a first transistor. The switching circuitry may include a diode (e.g., the diodes 313 and 314 of FIG. 3 and/or FIG. 9) including an anode connected to the signal path. The switching circuitry may include a second transistor (e.g., the transistor 315 of FIG. 3 and/or FIG. 9) including a drain electrode connected to a cathode of the diode, a source electrode connected to the ground node, and the gate electrode connected to the control circuitry.

For example, the control signal may be a first control signal. The control circuitry may be configured to transmit a second control signal for controlling the switching circuitry to the gate electrode of the second transistor.

For example, the electronic device may comprise a diode (e.g., the diodes 341 and 342 of FIG. 3 and/or FIG. 9) including an anode connected to the signal path and a cathode connected to the control circuitry. The control circuitry may be configured to control the switching circuitry based on a voltage of the signal path identified through the diode.

For example, the control circuitry may be configured to, based on identifying the voltage of the signal path greater than a threshold voltage in a time section to disable the electric connection between the port and the capacitor based on the transistor, control the switching circuitry to change the voltage of the signal path to a voltage of the ground node.

For example, the capacitor may be a first capacitor. The electronic device may comprise power factor correction circuitry (e.g., the power factor correction circuitry 230 of FIG. 2) configured to control charging of a second capacitor using a power of the first capacitor based on a power factor of the alternate current signal.

As described above, power circuitry (e.g., the power circuitry 170 of FIG. 1 and/or FIG. 2) according to an example embodiment may comprise a port to receive an alternate current signal. The power circuitry may comprise rectifying circuitry (e.g., the rectifying circuitry 220 of FIG. 2, the rectifying circuitry 220-1 of FIG. 3, and/or the rectifying circuitry 220-2 of FIG. 9) configured to rectify the alternate current signal. The power circuitry may comprise a capacitor configured to be charged by the alternate current signal rectified by the rectifying circuitry. The rectifying circuitry may comprise a diode including an anode coupled to the port and a cathode coupled to the capacitor. The rectifying circuitry may comprise a transistor including a drain electrode coupled to the anode and a source electrode coupled to a ground node. The rectifying circuitry may comprise control circuitry configured to transmit a control signal to a gate electrode of the transistor based on a voltage of the drain electrode. The rectifying circuitry may comprise switching circuitry, that is coupled to a signal path between the gate electrode and the control circuitry, configured to change a voltage of the gate electrode to a voltage of the ground node.

For example, the control circuitry may be configured to control the switching circuitry based on whether a rate of change of the voltage of the drain electrode is greater than a threshold rate of change.

For example, the capacitor may be a first capacitor. The power circuitry may comprise a second capacitor including an end connected to the drain electrode, and another end connected to the control circuitry.

For example, the control circuitry may be configured to identify an alternate current component of the voltage of the drain electrode, via the second capacitor. The control circuitry may be configured to control the switching circuitry based on the identified alternate current component.

For example, the transistor may be a first transistor. The switching circuitry may include a diode including an anode connected to the signal path. The switching circuitry may include a second transistor including a drain electrode connected to a cathode of the diode, a source electrode connected to the ground node, and a gate electrode connected to the control circuitry.

For example, the control circuitry may be configured to, based on identifying a rate of change of the voltage of the gate electrode greater than a threshold rate of change, transmit a control signal to establish an electric connection between the drain electrode and the source electrode of the second transistor, to the gate electrode of the second transistor.

For example, the diode may be a first diode. The power circuitry may include a second diode including an anode connected to the signal path and a cathode connected to the control circuitry. The control circuitry may be configured to control the switching circuitry, based on a voltage of the signal path identified through the second diode.

For example, the control circuitry may be configured to, based on identifying the voltage of the signal path greater than a threshold voltage in a second time section different from a first time section defined to activate the transistor to rectify the alternate current signal based on the rectifying circuitry, control the switching circuitry to change the voltage of the signal path to the voltage of the ground node.

For example, the capacitor may be a first capacitor. The power circuitry may further comprise power factor correction circuitry configured to control charging a second capacitor using a power of the first capacitor based on a power factor of the alternate current signal.

As described above, in an example embodiment, a method to control a transistor of rectifying circuitry may be provided. The method may comprise identifying a voltage of an alternate current signal transmitted to the recti5fying circuitry. The method may comprise identifying a rate of change of the voltage. The method may comprise, based on identifying the rate of change lower than or equal to a threshold rate of change, controlling the transistor based on a preset period for rectifying the alternate current signal. The method may comprise, based on identifying the rate of change greater than the threshold rate of change, changing a voltage of a gate electrode of the transistor to a voltage of a ground node.

For example, the method may comprise, while identifying the rate of change lower than or equal to the threshold rate of change, identifying the voltage of the gate electrode of the transistor. The method may comprise, based on the voltage greater than a threshold rate of change in a time section to disable the transistor for rectifying the alternate current signal, changing a voltage of the gate electrode of the transistor to a voltage of the ground node.

As used herein, the term “if” may, optionally, be understood as “when” or “upon” or “in response to determining” or “in response to detecting,” depending on the context. Similarly, the phrase “if it is determined” or “if [a stated condition or event] is detected” may, optionally, be understood as “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the disclosure may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a one of ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to various example embodiments may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although various example embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved. It will also be understood that any of the embodiments(s) described herein may be used in conjunction with any other embodiment(s) described herein.

Therefore, other implementations, embodiments, and the scope of the claims and their equivalents fall within the scope of disclosure.

What is claimed is:

1. An electronic device comprising:
a port configured to receive an alternating current signal;
a capacitor;
a transistor configured to control an electric connection between the port and the capacitor;
control circuitry connected to a gate electrode of the transistor; and
switching circuitry, coupled to a signal path between the gate electrode and the control circuitry, configured to connect the signal path to a ground node; and
wherein the control circuitry is configured to:
control, based on a voltage of the alternating current signal received through the port, the switching circuitry to transmit, to the ground node, a control signal to be transmitted to the gate electrode from the control circuitry through the signal path.

2. The electronic device of claim 1, further comprising:
a diode including an anode connected to the port and a cathode connected to the capacitor, and
wherein the transistor includes a drain electrode connected to the anode of the diode and a source electrode connected to the ground node.

3. The electronic device of claim 2, wherein the capacitor is a first capacitor, and
wherein the electronic device further comprises:
a second capacitor including an end connected to the anode of the diode and another end connected to the control circuitry.

4. The electronic device of claim 3, wherein the control circuitry is configured to:
identify a rate of change of the voltage of the alternating current signal through the second capacitor; and
based on identifying the rate of change being greater than a threshold rate of change, control the switching circuitry to transmit a control signal to be transmitted to the gate electrode from the control circuitry through the signal path, to the ground node.

5. The electronic device of claim 1, wherein the transistor is a first transistor,
wherein the switching circuitry includes:
a diode including an anode connected to the signal path; and
a second transistor including a drain electrode connected to a cathode of the diode, a source electrode connected to the ground node, and the gate electrode connected to the control circuitry.

6. The electronic device of claim 5, wherein the control signal is a first control signal, and
wherein the control circuitry is configured to:
transmit a second control signal for controlling the switching circuitry to the gate electrode of the second transistor.

7. The electronic device of claim 1, further comprising:
a diode including an anode connected to the signal path and a cathode connected to the control circuitry, and
wherein the control circuitry is configured to:
control the switching circuitry based on a voltage of the signal path identified through the diode.

8. The electronic device of claim 7, wherein the control circuitry is configured to:
based on identifying the voltage of the signal path being greater than a threshold voltage in a time section to disable the electric connection between the port and the capacitor based on the transistor, control the switching circuitry to change the voltage of the signal path to a voltage of the ground node.

9. The electronic device of claim 1, wherein the capacitor is a first capacitor, and
wherein the electronic device further comprises:
power factor correction circuitry configured to control charging of a second capacitor using a power of the first capacitor based on a power factor of the alternating current signal.

10. Power circuitry comprising:
a port configured to receive an alternating current signal;
rectifying circuitry configured to rectify the alternating current signal; and
a capacitor configured to be charged by the alternating current signal rectified by the rectifying circuitry;
wherein the rectifying circuitry comprises:
a diode including an anode coupled to the port and a cathode coupled to the capacitor;
a transistor including a drain electrode coupled to the anode and a source electrode coupled to a ground node;
control circuitry configured to transmit a control signal to a gate electrode of the transistor based on a voltage of the drain electrode; and
switching circuitry, coupled to a signal path between the gate electrode and the control circuitry, configured to change a voltage of the gate electrode to a voltage of the ground node.

11. The power circuitry of claim 10, wherein the control circuitry is configured to control the switching circuitry based on whether a rate of change of the voltage of the drain electrode is greater than a threshold rate of change.

12. The power circuitry of claim 10, wherein the capacitor is a first capacitor, and the power circuitry comprises a second capacitor including an end connected to the drain electrode, and another end connected to the control circuitry.

13. The power circuitry of claim 12, wherein the control circuitry is configured to:
identify an alternating current component of the voltage of the drain electrode, via the second capacitor; and
control the switching circuitry based on the identified alternating current component.

14. The power circuitry of claim 10, wherein the transistor is a first transistor,
wherein the switching circuitry includes:
a diode including an anode connected to the signal path; and
a second transistor including a drain electrode connected to a cathode of the diode, a source electrode connected to the ground node, and a gate electrode connected to the control circuitry.

15. The power circuitry of claim 14, wherein the control circuitry is configured to:
based on identifying a rate of change of the voltage of the gate electrode being greater than a threshold rate of change, transmit a control signal to establish an electric connection between the drain electrode and the source electrode of the second transistor, to the gate electrode of the second transistor.

16. The power circuitry of claim 10, wherein the diode is a first diode,
wherein the power circuitry includes a second diode including an anode connected to the signal path and a cathode connected to the control circuitry, and
wherein the control circuitry is configured to control the switching circuitry, based on a voltage of the signal path identified through the second diode.

17. The power circuitry of claim 16, wherein the control circuitry is configured to:
based on identifying the voltage of the signal path being greater than a threshold voltage in a second time section different from a first time section defined to activate the transistor to rectify the alternating current signal based on the rectifying circuitry, control the switching circuitry to change the voltage of the signal path to the voltage of the ground node.

18. The power circuitry of claim 10, wherein the capacitor is a first capacitor, and the power circuitry further comprising:
power factor correction circuitry configured to control charging a second capacitor using a power of the first capacitor based on a power factor of the alternate current signal.

19. A method of controlling a transistor of rectifying circuitry, comprising:
identifying a voltage of an alternating current signal transmitted to the rectifying circuitry;
identifying a rate of change of the voltage;
based on identifying the rate of change being lower than or equal to a threshold rate of change, controlling the transistor based on a specified period for rectifying the alternate current signal; and
based on identifying the rate of change being greater than the threshold rate of change, changing a voltage of a gate electrode of the transistor to a voltage of a ground node.

20. The method of claim 19, further comprising:
while identifying the rate of change being lower than or equal to the threshold rate of change:
identifying the voltage of the gate electrode of the transistor; and
based on the voltage being greater than a threshold rate of change in a time section to disable the transistor for rectifying the alternating current signal, changing a voltage of the gate electrode of the transistor to a voltage of the ground node.
